(19) United States
(12) Patent Application Publication
(10) Pub. No.: US 2013/0122861 A1
(43) Pub. Date: May 16, 2013

(54) SYSTEM AND METHOD FOR VERIFYING APPS FOR SMART PHONE

(71) Applicants: Young-Wook KIM, Yongin-si (KR); Tae-Hyung KIM, Gyeongju-si (KR); Hyung-Geun OH, Daejeon (KR); Sang-Woo PARK, Daejeon (KR); E-Joong YOON, Daejeon (KR)

(72) Inventors: Young-Wook KIM, Yongin-si (KR); Tae-Hyung KIM, Gyeongju-si (KR); Hyung-Geun OH, Daejeon (KR); Sang-Woo PARK, Daejeon (KR); E-Joong YOON, Daejeon (KR)

(73) Assignee: ELECTRONICS AND TELECOMMUNICATIONS RESEARCH INSTITUTE, Daejeon (KR)

(21) Appl. No.: 13/463,656

(22) Filed: May 3, 2012

(30) Foreign Application Priority Data
Nov. 11, 2011 (KR) 10-2011-0117594

(51) Int. Cl. H04W 12/00

(52) U.S. Cl. 455/410

(57) ABSTRACT

A system and method for verifying apps for a smart phone are provided. The system for verifying apps for a smart phone includes an app auto-verification device and an app self-verification device. The app auto-verification device analyzes the installation tile of an app to be installed in the smart phone, constructs a scenario, executes the app in the smart phone in accordance with the scenario, and determines malicious behavior using the results of the execution. The app self-verification device monitors an installation file corresponding to an app to be installed in the smart phone, and determines malicious behavior by analyzing a behavioral log corresponding to results of the monitoring.

### CROSS REFERENCE TO RELATED APPLICATION

This application claims the benefit of Korean Patent App No. 10-2011-0117594, filed on Nov. 11, 2011, which is hereby incorporated by reference in its entirety into this application.

### BACKGROUND OF THE INVENTION

1. Technical Field

The present invention relates generally to a system and method for verifying apps (applications) for a smart phone and, more particularly, to a system and method for verifying apps for a smart phone, which are capable of examining smart phone apps for malicious behavior.

2. Description of the Related Art

With the transition from conventional general mobile phones (for example, feature phones) to smart phones, the number of malicious apps for smart phones tends to be increasing.

As the hardware of smart phones becomes more advanced and application programs for smart phones are more diversified and complicated, the possibility of malware causing serious damage to smart phones is increasing. In particular, in line with the spread of wireless mobile Internet service such as WiBro, a variety of types of mobile malware, which attack the weakness of application programs and services for mobile terminals such as Bluetooth and a Multimedia Messaging System (MMS), are appearing. Such a variety of types of malware may cause serious damage, such as the erroneous operation of a smart phone, the deletion of data or the leakage of personal information. Accordingly, there is a need for a countermeasure which is capable of effectively protecting smart phones against a variety of types of malware.

### SUMMARY OF THE INVENTION

Accordingly, the present invention has been made keeping in mind the above problems occurring in the prior art, and an object of the present invention is to provide a system and method for verifying apps for a smart phone, which are capable of performing auto-verification and self-verification related to the malicious behavior of apps for a smart phone.

In order to accomplish the above object, the present invention provides a system for verifying apps for a smart phone, including an app auto-verification device for analyzing an installation file of an app to be installed in the smart phone, constructing a scenario, executing the app in the smart phone in accordance with the scenario, and determining malicious behavior using results of the execution; and an app self-verification device for monitoring an installation file corresponding to an app to be installed in the smart phone, and determining malicious behavior by analyzing a behavioral log corresponding to results of the monitoring.

The app auto-verification device may include an app management unit for analyzing the installation file of the app, identifying specific conditions under which individual functions of the app can be executed, and constructing the scenario based on results of the identification; and a malicious behavior detection unit for receiving and analyzing the behavioral log corresponding to the results of the execution from the smart phone, and determining the malicious behavior based on results of the analysis.

The system may further include a storage unit for storing results of the determination of the malicious behavior obtained by the malicious behavior detection unit.

When a request for verification of an app which is the same as the app installed in the smart phone is received, the results stored in the storage unit may be transferred to the smart phone.

The app self-verification device may include an installation file determination unit for examining whether the pattern of the malicious behavior has been included in the installation file.

Additionally, in order to accomplish the above object, the present invention provides a method of verifying apps for a smart phone, wherein a system for verifying apps for a smart phone verifies apps while operating in conjunction with an app market and a smart phone, the method including selecting an app for the smart phone for verification; downloading the selected app for the smart phone from the app market, and analyzing an installation file of the downloaded app; constructing a scenario based on results of the analysis of the installation file of the app; installing an app corresponding to the scenario in the smart phone, and transmitting execution commands to the smart phone in accordance with the scenario; and verifying the app for the smart phone by receiving results corresponding to the execution commands and then determining malicious behavior.

The verifying may include receiving a behavioral log corresponding to the execution commands from the smart phone, and analyzing the behavioral log; and determining the malicious behavior based on results of the analysis.

Additionally, in order to accomplish the above object, the present invention provides a method of verifying apps for a smart phone, wherein a system for verifying apps for a smart phone verifies apps while operating in conjunction with an app market and a smart phone, the method including receiving a request for verification of an app from the smart phone; installing an app corresponding to the request for verification; recording a behavioral log corresponding to results of execution of the installed app; and verifying the app for the smart phone by analyzing the behavioral log and then determining malicious behavior of the app.

The method may further include, if results of verification of an app corresponding to the request for verification exist, transmitting the results of verification to the smart phone.

The verifying may include verifying the app for the smart phone by determining whether a pattern of malicious behavior has been included in an installation file included in the request for verification.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating an environment to which a system for verifying apps for a smart phone according to an embodiment of the present invention is applied;

FIG. 2 is a diagram showing the configuration of an app auto-verification device according to a first embodiment of the present invention;

FIG. 3 is a diagram showing the configuration of a smart phone according to the first embodiment of the present invention;

FIG. 4 is a flowchart illustrating a method for automatically verifying an app for a smart phone according to the first embodiment of the present invention;

FIG. 5 is a diagram showing the configuration of a smart phone according to a second embodiment of the present invention:

FIG. 6 is a diagram showing the configuration of an app self-verification device according to the second embodiment of the present invention; and

FIG. 7 is a flowchart illustrating a method of performing self-verification on an app for a smart phone according to the second embodiment of the present invention.

### DESCRIPTION OF THE PREFERRED EMBODIMENTS

Reference now should be made to the drawings, throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

A system and method for verifying apps for a smart phone according to embodiments of the present invention will be described in detail below with reference to the accompanying drawings.

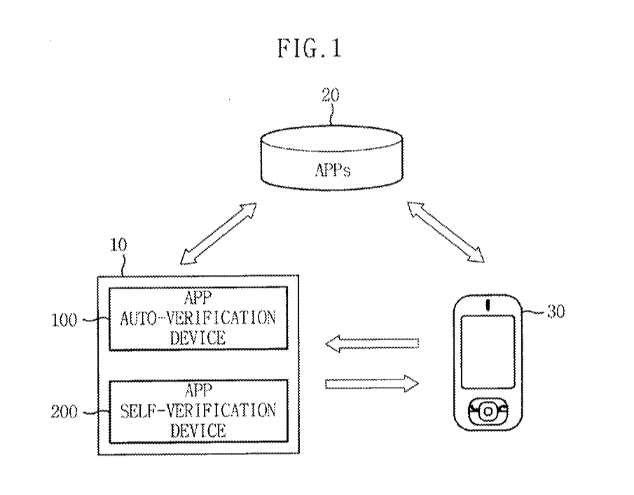

FIG. 1 is a diagram schematically illustrating an environment to which a system 10 for verifying apps for a smart phone according to an embodiment of the present invention is applied.

Referring to FIG. 1, the system 10 for verifying apps (applications) for a smart phone according to the embodiment of the present invention performs an app auto-verification process and an app self-verification process while operating in conjunction with an app market APPs (hereinafter referred to as an “app market”) 20 and a smart phone 30. For this purpose, the system 10 for verifying apps for a smart phone includes an app auto-verification device 100 and an app self-verification device 200. Although the system 10 for verifying apps for a smart phone according to the embodiment of the present invention is illustrated as including the app auto-verification device 100 and the app self-verification device 200, the present invention is not limited thereto.

The app auto-verification device 100 automatically performs the process of downloading an app from the app market 20, and installing, executing and analyzing the app (an app auto-verification process). Furthermore, the app auto-verification device 100 analyzes the installation file of the app to be installed in the smart phone 30, identifies specific conditions under which malicious behavior can be revealed, constructs a scenario based on identification results, and causes the malicious behavior to be revealed (a scenario-based malicious behavior triggering process). Here, the malicious behavior is, for example, behavior in which specific malware is applied to an app and prevents the normal operation of the app from being performed, but is not limited thereto.

The app auto-verification process is the process of automatically performing the download, installation, execution and analysis of an app in order to reduce consumptive efforts which are made to repeatedly perform the download, installation, execution and analysis of the app so as to analyze the app to be installed in the smart phone 30. Furthermore, the scenario-based malicious behavior triggering process is the process of detecting malicious behavior which is performed only under specific conditions. The malicious app may be a malicious app which performs malicious behavior immediately after it is executed, or a malicious app which performs malicious behavior when specific conditions are fulfilled. Accordingly, the scenario-based malicious behavior triggering process includes the process of identifying specific conditions and the process of constructing a scenario so that specific conditions can be fulfilled and then revealing malicious behavior.

The app auto-verification device 100 receives a log of behavior (hereinafter also referred to as the “behavioral log”), corresponding to the app installed in the smart phone 30, from the smart phone 30, and determines whether behavior is malicious based on the received behavioral log.

The app self-verification device 200 downloads an app from the app market 20, installs and executes the app in the smart phone 30, monitors its access to important resources, and records monitoring results in a behavioral log. Thereafter, the app self-verification device 200 determines malicious behavior by analyzing the behavioral log. Furthermore, the app self-verification device 200 checks for the pattern of malicious behavior using binary file static analysis.

The smart phone 30 operates in conjunction with the app auto-verification device 100 and the app self-verification device 200 which are included in the system 10 for verifying apps for a smart phone.

According to a first embodiment of the present invention, the smart phone 30 receives an app installation command from the app auto-verification device 100, and installs and executes the corresponding app. Here, the smart phone 30 executes the app using a dynamic behavior analysis process, and records various types of behavior corresponding to execution results in a log (hereinafter referred to as a “behavioral log”). Here, the dynamic behavior analysis process is the process of modifying the Operating System (OS) of the smart phone 30, causing additional information, such as an Application Programming interface (API) and a parameter invoked by an app, to be recorded in a log, and analyzing a log obtained by installing and executing the app on the modified OS, thereby determining malicious behavior.

According to a second embodiment of the present invention, the smart phone 30 automatically transmits the installation file and additional information of the installed app to the app self-verification device 200.

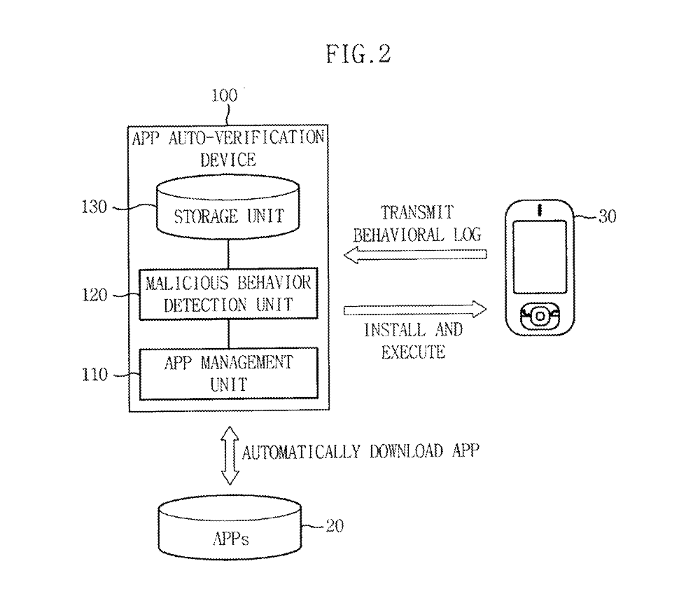

Thereafter, the app auto-verification device 100 according to the first embodiment of the present invention will now be described in detail with reference to FIG. 2.

FIG. 2 is a diagram showing the configuration of the app auto-verification device 100 according to the first embodiment of the present invention.

First, the app auto-verification device 100 according to the first embodiment of the present invention may be implemented in a specific PC, but is not limited thereto. Furthermore, the smart phone 30 which operates in conjunction with the app auto-verification device 100 may correspond to a device which performs a dynamic behavior analysis process, but is not limited thereto.

Referring to FIG. 2, the app auto-verification device 100 includes an app management unit 110, a malicious behavior detection unit 120, and a storage unit 130.

The app management unit 110 downloads an app to be verified from the app market 20, and installs the downloaded app. Furthermore, the app management unit 110 identifies specific conditions under which the individual functions of the app can be performed by analyzing the installation file of the installed app, and constructs a scenario based on identification results. Thereafter, the app management unit 110 installs the app, for which the scenario has been constructed, in the smart phone 30.

The malicious behavior detection unit 120 analyzes the behavioral log received from the smart phone 30, and determines whether behavior is malicious based on analysis results.

The storage unit 130 stores the analysis results obtained by the malicious behavior detection unit 120. When receiving a request for the verification of an app which is the same as an app installed in the smart phone 30, the storage unit 130 transfers the stored results, thereby reducing the load of the app auto-verification device 100.

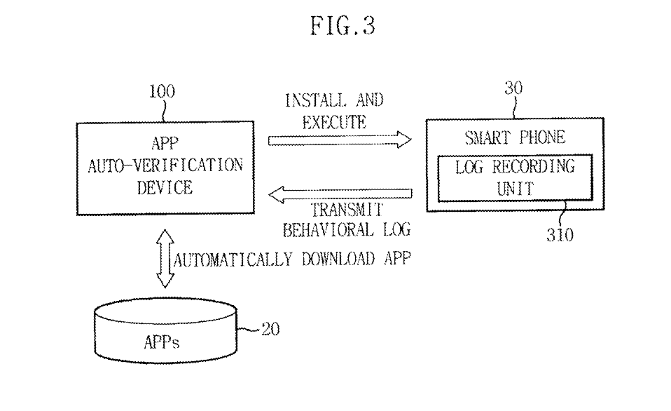

Next, the smart phone 30 according to the first embodiment of the present invention will be described in detail with reference to FIG. 3.

FIG. 3 is a diagram showing the configuration of the smart phone 30 according to the first embodiment of the present invention.

Referring to FIG. 3, the smart phone 30 according to the first embodiment of the present invention includes a log recording unit 310 which records behavior, corresponding to an app being executed, as a log.

The log recording unit 310 records behavior, which is performed by the app while the app is being installed and executed in response to remote commands received from the app management unit 110 of the app auto-verification device 100, as a log. Once the execution is completed, the log recording unit 310 transmits the recorded log, that is, behavioral log, to the malicious behavior detection unit 120 of the app auto-verification device 100.

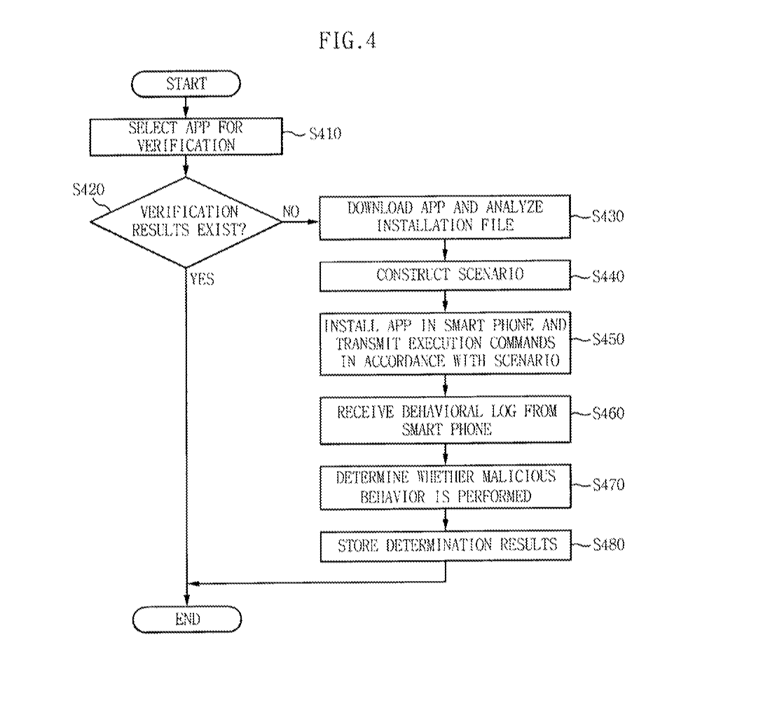

Next, a method in which the app auto-verification device 100 automatically verifies an app for the smart phone 30 will be described in detail with reference to FIG. 4.

FIG. 4 is a flowchart illustrating the method for automatically verifying an app for a smart phone according to the first embodiment of the present invention.

Referring to FIG. 4, the app auto-verification device 100 selects an app for the smart phone 30 for verification at step S410.

The app auto-verification device 100 determines whether verification results related to the selected app have been stored in the storage unit 130 at step S420. If the verification results related to the selected app have been stored in the storage unit 130, the app auto-verification device 100 returns the stored verification results.

If the verification results related to the selected app have not been stored in the storage unit 130, the app auto-verification device 100 downloads the selected app and analyzes the installation file of the downloaded app at step S430.

The app auto-verification device 100 constructs a scenario based on the results of the analysis of the installation file of the app at step S440. In greater detail, the app auto-verification device 100 identifies specific conditions under which the individual functions of the app can be executed by analyzing the installation file of the app, and constructs a scenario based on identification results.

The app auto-verification device 100 installs an app corresponding to the constructed scenario in the smart phone 30 and transmits execution commands to the smart phone 30 in accordance with the constructed scenario at step S450. In this case, the smart phone 30 executes the app using a dynamic behavior analysis process, and records various types of behavior corresponding to execution results as a log (a behavioral log).

The app auto-verification device 100 receives the behavioral log from the smart phone 30 at step 5460.

The app auto-verification device 100 analyzes the received behavioral log and determines whether the behavior is malicious based on analysis results at step S470.

The app auto-verification device 100 stores the results of the determination of whether the behavior is malicious at step S480. Here, when receiving a request for the verification of an app which is the same as the app installed in the smart phone 30, the app auto-verification device 100 transfers the stored results, thereby reducing the load of the app auto-verification device 100.

Next, a smart phone 30 according to a second embodiment of the present invention will be described in detail with reference to FIG. 5.

FIG. 5 is a diagram showing the configuration of the smart phone 30 according to the second embodiment of the present invention.

Referring to FIG. 5, the smart phone 30 according to the second embodiment of the present invention transfers the installation file and additional information of an app, receives corresponding results, and installs or deletes the app. For this purpose, the smart phone 30 includes an app management unit 320 and a verification client 330.

The app management unit 320 downloads the app from the app market 20, and determines whether to install or delete the downloaded app based on verification results.

The verification client 330 requests the verification of the app from the app self-verification device 200, receives app verification results corresponding to the verification request from the app self-verification device 200. and transfers the app verification results to the app management unit 320.

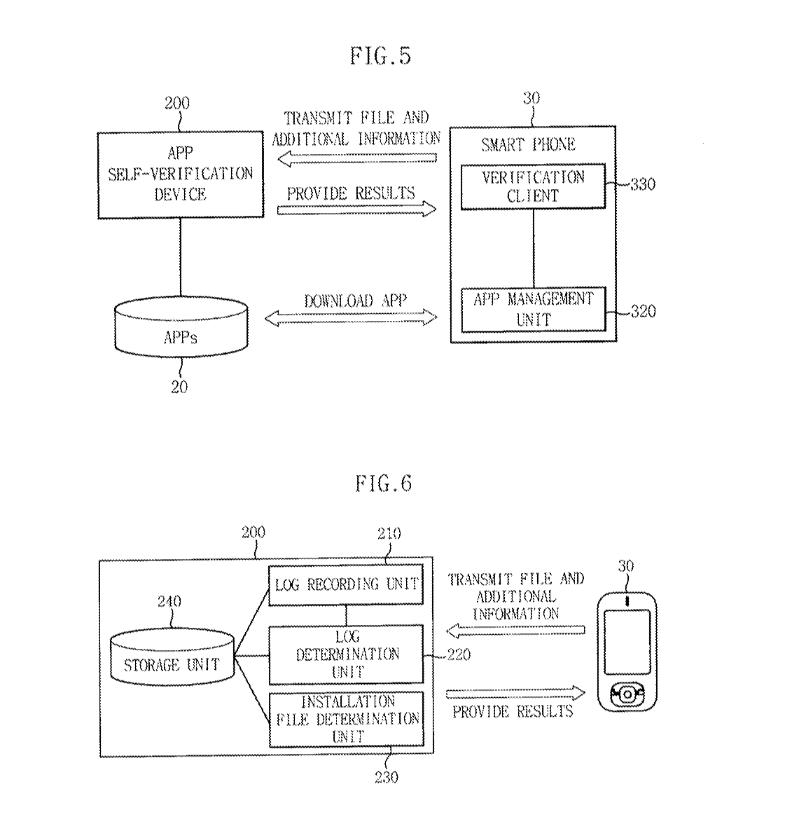

Next, the app self-verification device 200 according to the second embodiment of the present invention will be described in detail with reference to FIG. 6.

FIG. 6 is a diagram showing the configuration of the app self-verification device 200 according to the second embodiment of the present invention.

Referring to FIG. 6, the app self-verification device 200 includes a log recording unit 210, a log determination unit 220, an installation file determination unit 230, and a storage unit 240.

The log recording unit 210 determines whether verification results corresponding to an installation file and the additional information of the installation file, received from the smart phone 30, exist in the storage unit 240.

In greater detail, if the verification results exist in the storage unit 240, the log recording unit 210 returns the verification results, stored in the storage unit 240, to the smart phone 30. In contrast, if the verification results do not exist in the storage unit 240, the log recording unit 210 downloads the corresponding app from the app market 20, installs and executes it, and records a behavioral log related to access to important resources.

In order to determine whether the verification results exist in the storage unit 240, the log recording unit 210 may utilize additional information, such as a download URK file hash value, as well as the name of the corresponding file.

The log determination unit 220 determines whether the behavior of the app is malicious by analyzing the recorded behavioral log. Furthermore, the log determination unit 220 stores the results of the determination of whether the behavior of the app is malicious in the storage unit 240.

The installation file determination unit 230 examines whether the pattern of malicious behavior has been included by applying a binary file static analysis method to the installation file received from the smart phone 30. Furthermore, the installation file determination unit 230 stores the results of the examination of whether the pattern of malicious behavior has been included in the storage unit 240.

The storage unit 240 stores the installation file, received from the smart phone 30, along with a unique value corresponding to the app, such as a hash value. Accordingly, the log recording unit 210 may search the storage unit 240 and return the results without repeatedly performing a verification process when a request for the verification of the same app will be made in the future.

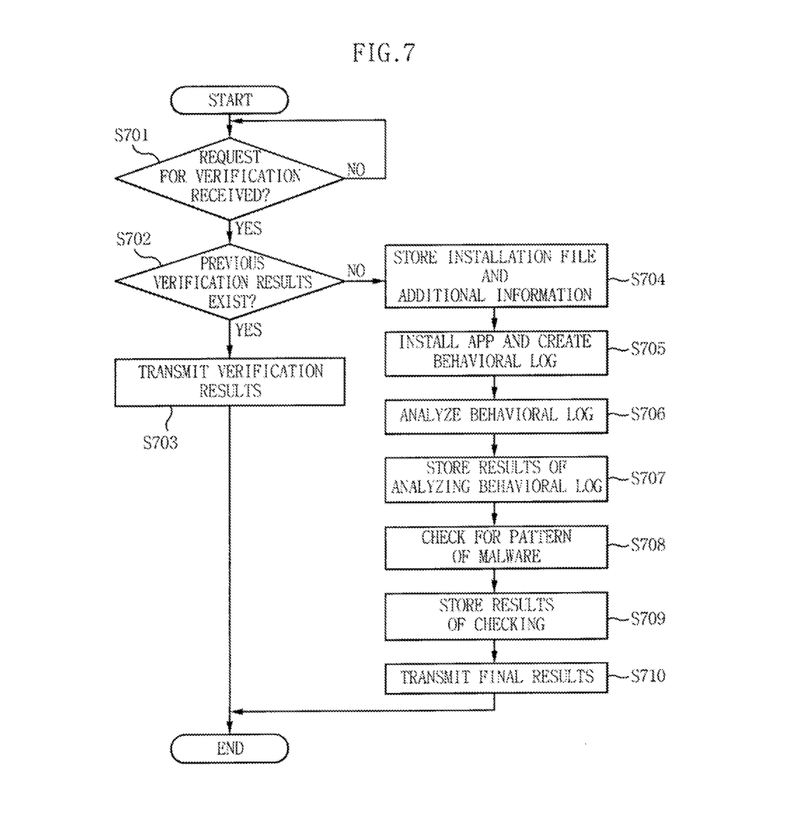

Next, a method in which the app self-verification device 200 performs self-verification on an app for the smart phone 30 will be described in detail with reference to FIG. 7.

FIG. 7 is a flowchart illustrating the method of performing self-verification on an app for the smart phone 30 according to the second embodiment of the present invention.

Referring to FIG. 7, the app self-verification device 200 determines whether a request for the verification of a corresponding app has been received from the smart phone 30 at step S701. If the request for the verification has not been received, the app self-verification device 200 waits until a request for the verification of an app has been received from the smart phone 30.

If the request for the verification has been received, the app self-verification device 200 determines whether verification results corresponding to an installation file included in the request for the verification and the additional information of the installation file exist in the storage unit 240 at step S702. In this case, the app self-verification device 200 may search for the verification results using the name of the installation file, a URL, a hash value or the like, but is not limited thereto.

If the verification results exist in the storage unit 240, the app self-verification device 200 returns the verification results, stored in the storage unit 240, to the smart phone 30 at step S703.

If the verification results do not exist in the storage unit 240, the app self-verification device 200 stores an installation file and the additional information of the installation file, included in the request for the verification, in the storage unit 240 at step S704. Furthermore, the app self-verification device 200 notifies the smart phone 30 of the nonexistence of the verification results in the storage unit 240. Thereafter, the app self-verification device 200 downloads the corresponding app from the app market 20, installs and executes it, and then records a behavioral log related to access to important resources at S705.

The app self-verification device 200 determines whether the behavior of the app is malicious by analyzing the recorded behavioral log at step S706. Furthermore, the app self-verification device 200 stores the results of the determination of whether the behavior of the app is malicious in the storage unit 240 at step 5707.

The app self-verification device 200 examines whether the pattern of malicious behavior has been included, in the installation file received from the smart phone 30 at step S708. Furthermore, the app self-verification device 200 stores the results of the examination of whether the pattern of malicious behavior has been included in the installation file in the storage unit 240 at step S709.

The app self-verification device 200 finally transfers the results of the determination of whether the behavior of the app is malicious and the results of the examination of whether the pattern of malicious behavior has been included in the installation file installation file to the smart phone 30 at step S710.

As described above, the present invention is capable of examining whether apps for a smart phone are malicious in order to prevent malicious apps for a smart phone from spreading.

The present invention has the advantage of preventing malicious apps from spreading via an app market using an app verification process. Furthermore, the present invention has the advantage of preemptively verifying apps before registering them in the app market, thereby preemptively blocking apps in the case where the apps include malware. In particular, the present invention has the advantage of verifying malicious behavior which can be performed only under specific conditions, using a scenario-based malicious behavior triggering process.

Furthermore, the present invention has the advantage of the app auto-verification device enabling a mobile communication provider to protect its app market using an automated analysis process.

The present invention has the advantage of the app self-verification device performing self-verification on downloaded apps, so that the infection of a smart phone with malware can be preemptively blocked, thereby protecting the smart phone from damages such as Distributed Denial of Service (DDoS) or the leakage of personal information.

Although the preferred embodiments of the present invention have been disclosed for illustrative purposes. those skilled in the art will appreciate that various modifications, additions and substitutions are possible, without departing from the scope and spirit of the invention as disclosed in the accompanying claims.

What is claimed is:

1. A system for verifying apps for a smart phone, comprising:
an app auto-verification device for analyzing an installation file of an app to be installed in the smart phone, constructing a scenario, getting the app to be executed in the smart phone in accordance with the scenario, and determining malicious behavior using results of the execution of the app; and
an app self-verification device for monitoring an installation file corresponding to an app installed in the smart phone, and determining malicious behavior by analyzing a behavioral log corresponding to results of the monitoring.

2. The system as set forth in claim I, wherein the app auto-verification device comprises:
an app management unit for analyzing the installation file of the app, identifying specific conditions under which individual functions of the app can be executed, and constructing the scenario based on results of the identification; and
a malicious behavior detection unit for receiving and analyzing the behavioral log corresponding to the results of the execution of the app from the smart phone, and determining the malicious behavior based on results of the analysis.

3. The system as set forth in claim 2, further comprising a storage unit for storing results of the determination of the malicious behavior obtained by the malicious behavior detection unit

4. The system as set forth in claim 3, wherein the system transfers the results stored in the storage unit to the smart phone, when a request for verification of an app which is identical to the app installed in the smart phone is received.

5. The system as set forth in claim 1, wherein the app self-verification device comprises an installation file determination unit for examining whether a pattern of the malicious behavior has been included in the installation file.

6. A method of verifying apps for a smart phone, the method comprising:
selecting an app for a smart phone for verification;
downloading the selected app for the smart phone from an app market, and analyzing an installation file of the downloaded app;
constructing a scenario based on results of the analysis of the installation file of the app;
installing an app corresponding to the scenario in the smart phone, and transmitting execution commands to the smart phone in accordance with the scenario; and
verifying the app for the smart phone by receiving results corresponding to the execution commands and then determining malicious behavior.

7. The method as set forth in claim 6, wherein the verifying comprises:
receiving a behavioral log corresponding to the execution commands from the smart phone, and analyzing the behavioral log; and
determining the malicious behavior based on results of the analysis.

8. A method of verifying apps for a smart phone, the method comprising:
receiving a request for verification of an app from a smart phone;
installing an app corresponding to the request for verification;
recording a behavioral log corresponding to results of execution of the installed app; and
verifying the app for the smart phone by analyzing the behavioral log and then determining malicious behavior of the app.

9. The method as set forth in claim 8, further comprising, if results of verification of an app corresponding to the request for verification already exist, transmitting the results of verification to the smart phone.

10. The method as set forth in claim 8, wherein the verifying comprises verifying the app for the smart phone by determining whether a pattern of malicious behavior has been included in an installation file included in the request for verification.
